(19) United States
(12) Patent Application Publication
(10) Pub. No.: US 2018/0172601 A1
(43) Pub. Date: Jun. 21, 2018

(54) METHOD OF INSPECTING A STEEL STRIP

(71) Applicants: Thyssenkrupp Rasselstein GmbH, Andemach (DE); Thyssenkrupp AG, Essen (DE)

(72) Inventors: Michael Wild, Neuwied Irlich (DE); Thomas Nollen, Bendorf (DE)

(73) Assignees: Thyssenkrupp Rasselstein GmbH, Andernach (DE); Thyssenkrupp AG, Essen (DE)

(21) Appl. No.: 15/832,144

(22) Filed: Dec. 5, 2017

(30) Foreign Application Priority Data
Dec. 15, 2016 (DE) 10 2016 124 522.4

(51) Int. Cl. G01N 21/89; G01N 21/88; G01N 27/83; G06T 7/00

(52) U.S. Cl. CPC G01N 21/8914; G01N 21/8806; G01N 2021/8918; G06T 7/0004; G01N 2021/8867; G01N 27/83

(57) ABSTRACT

In a method of inspecting a steel strip, at least one surface of the steel strip is illuminated and scanned by at least one camera so as to generate an image record that defines a two-dimensional image of the scanned surface. The image record is sent to an image processing unit, with the image processing unit subjecting the image record to the detection of defects and, upon detection of a surface defect, classifying the detected surface defect. The steel strip is magnetized and the magnetic flux leakage on the surface of the steel strip is detected by at least one magnetic field-sensitive flux leakage sensor in order to detect inhomogeneities in the interior of the steel strip, with the flux leakage sensor generating a flux leakage record that is sent to the image processing unit and that is subjected by the image processing unit to the detection of defects so as to identify inhomogeneities in the interior of the steel strip.

### FIELD OF THE INVENTION

The present invention relates to a method of inspecting a steel strip and to a system for carrying out the method.

### BACKGROUND

Automatic systems for inspecting the surface of steel strips are known from the prior art, wherein the quality of the surface of the steel strip is determined for the purpose of quality control. To this end, the surface of a steel strip exiting a production or finishing process and moving at a given strip speed is monitored in-line by means of cameras which acquire a two-dimensional image of the surface of the moving steel strip. In processes of the cold rolling of steel strips, the strip speeds are typically greater than 1400 m/min, and in typical steel strip finishing processes, for example, in strip tin-plating plants, the strip speeds are in a range of 20 m/min to 700 m/min. The steel strips can be uncoated or coated steel strips, in particular steel strips with an anti-corrosive coating (for example, tin-plated or galvanized steel strips); if the steel strip is coated, the cameras monitor the surface quality of the coating.

As a rule, a surface inspection of (coated or uncoated) steel strips takes place immediately after completion of the production and finishing or coating process and prior to winding the steel strip into a coil. The surface inspection is generally performed by specially trained inspectors who visually monitor the surface of the steel strip while the steel strip is moving at the strip speed. To aid the visual surface inspection by an inspector, automated surface inspection systems are used, which are generally equipped with a plurality of cameras which scan the surface of the moving steel strip and capture a two-dimensional image of the scanned surface. The image of the surface of the steel strip acquired by the cameras of the inspection system is analyzed by means of image processing programs so as to detect anomalies or surface defects. Typical surface defects of steel strips include, for example, scratches, surface breaking defects, oxidations, oxide slag streaks or contaminations and foreign bodies. Such surface defects on steel strips are especially unacceptable or at least undesirable if the steel strip is to be used to produce products, the surface of which is visible during the intended use of the product, or if, during the production of the products, the steel strips are subjected to deformations (for example, in the deep drawing process or in the ironing process) since during deformation, such surface defects can cause a decrease in the stability of the product formed. On coated steel strips, surface defects in the anti-corrosive coating can also decrease corrosion resistance.

WO 2015/022271 A1, for example, discloses a method of detecting defects on a flat surface of a metal product, in particular a metal strip, by means of which it is possible reliably to detect and classify small and extremely small defects on the examined surface. To this end, a surface section to be examined is illuminated by a lighting unit, and, using a camera unit, at least two images are captured at different exposures and sent to an image processing unit. The images acquired at different exposures are superimposed in the image processing unit so that even small and extremely small surface defects can be detected.

If, during the inspection of a steel strip, a surface defect considered to be unacceptable for the intended use of the steel strip is detected, the section of the steel strip in which the surface defect appears can be cut out and discarded as reject material. To make this possible, it is necessary to perform the surface inspection in-line and to analyze it very quickly and reliably. Since an automated surface inspection system captures two-dimensional images of the surface of the moving steel strip and, in the course thereof, detects a large number of critical as well as noncritical surface defects, it is necessary to send the two-dimensional images captured on-line by the surface inspection system to an image processing unit in which the two-dimensional images are analyzed in order to detect anomalies and surface defects. Because of the large number of possible and, to some extent, very different defects (anomalies, surface defects, contaminations and foreign bodies), it is necessary to classify the large number of defects detected by the image processing software. In the event of an accumulated occurrence of certain defects, it is possible to intervene in the production or finishing process if the surface defects are detected on-line by the surface inspection system and are analyzed and classified on-line in the image processing unit.

EP 1 737 587 B1 discloses a method of processing surface data and of analyzing the quality of strip material in which such a classification is performed. EP 1 901 230 A1 describes a method of automatically inspecting the surface of a moving strip, which allows the detected defects to be promptly and accurately analyzed based on an on-line classification.

During the production of steel strips, nonmetallic or oxide inclusions or defects in the steel can develop as a feature inherent to the production. Especially in thin steel sheets in the fine or superfine range (with a thickness of 3 mm or less and 0.6 mm or less, respectively), even the smallest inclusions can lead to material defects, and thus to reject material, in downstream processes, for example, in forming processes. Internal inclusions located deep within the steel strip defy detection by visual inspection of the steel strip and especially inspection by means of conventional optical surface inspection systems. To detect inclusions located deep within the steel strip, it is known that magnetic or magneto-inductive testing methods, for example, the magnetic flux leakage testing method, can be used. For example, DE 20 2014 104 374 U1 discloses a testing station for measuring the magnetic flux leakage. In magnetic flux leakage tests, the steel strip is magnetized, and the magnetic flux leakage generated by the magnetization is detected by means of magnetic field-sensitive sensors. The magnitude of the flux leakage depends upon the magnetization and the permeability of the steel strip tested as well as upon potentially present inclusions in the interior of the steel strip. If the magnetization and the permeability of the steel strip remain constant, a locally changing flux leakage, which is detected on the surface of the steel strip by means of the magnetic field-sensitive sensor, may be indicative of an internal defect, particularly, a nonmetallic inclusion in the steel strip.

However, in the inspection of steel strips, the analysis of the signals measured by magnetic field-sensitive sensors is, as a rule, limited to a purely statistical detection of the number of defects per unit area. Generally, it is, however, not possible to determine the nature and morphology of the defects.

### SUMMARY OF THE INVENTION

Taking this as the starting point, one aspect of the present invention relates to a method of and a system for inspecting a steel strip, which allow both surface defects and internal inclusions in the steel strip to be detected. At the same time, a reliable and rapid detection of defects should be made possible, particularly on-line while the steel strip is moving. In addition, it should be possible to differentiate between and classify different types of defects, which in some areas appear on the surface and in some areas only in the interior of the steel strip in the form of internal inclusions.

Preferred embodiments of the method and the system are disclosed.

According to the method of inspecting a steel strip according to an embodiment of the present invention, at least one of the two surfaces of the steel strip is illuminated and scanned by a minimum of one camera. Scanning the surface of the steel strip preferably takes place while the steel strip is moving, with the camera preferably scanning the surface of the steel strip line by line at right angles relative to the direction of strip travel. In doing so, the camera captures an image record which defines a two-dimensional image of the scanned surface. The image record is sent to an image processing unit for analysis in which the record is analyzed so as to detect defects. The image processing unit generally comprises an image processing program which is able to detect anomalies in the image record and to store them in a database. The anomalies in the image record detected in the image processing unit are classified so as to be able to detect a typical surface defect, for example, by comparing said defect with known anomalies and to correlate them with known surface defects. The classification of the identified anomalies in the image record and their categorization as surface defects takes place, for example, by comparing the detected anomaly in the image record with surface defects known from previous measurements, which are stored in a classification database.

To be able to detect and localize not only the surface defects obtained from the image record which can be detected by the image processing unit, but also internal inclusions in the steel strip, the method according to an embodiment of the present invention provides for the magnetization of the steel strip and for the detection of the magnetic flux leakage on the surface of the steel strip by means of at least one magnetic field-sensitive flux leakage sensor. This allows inhomogeneities in the interior of the steel strip to be detected. For this purpose, the flux leakage sensor generates a flux leakage record which is sent for analysis to the image processing unit where it is subjected to the detection of defects. To detect the presence of an inhomogeneity, for example, in the form of an internal nonmetallic inclusion, in the interior of the steel strip, the flux leakage record is checked for anomalies in the image processing unit, and potentially present anomalies are subjected to a classification in the image processing unit so as to be able to correlate the detected anomaly with an inhomogeneity in the interior of the steel strip. This can again be done, for example, by comparing an identified anomaly in the flux leakage record with classified defects in the form of inhomogeneities in the interior of the steel strip by comparing the identified anomaly with typical (previously known) and classified defects which are stored in a defect database.

In the image processing unit, in particular in the image processing program which subjects both the image record of the camera and the flux leakage record of the flux leakage sensor to the detection of defects, the data of the image record and the data of the flux leakage record can be combined in such a way that, in particular, by superimposing the data, a three-dimensional image of the defects of the steel strip can be acquired. The three-dimensional image of the defects of the steel strip acquired in this manner allows the detection and classification, for example, of a contiguous defect which in some areas appears as a surface defect on a surface of the steel strip (and which can be seen in the image record) and which in some areas is present at the same time in the form of an inhomogeneity (for example, a nonmetallic inclusion) in the interior of the steel strip without being visible on the surface.

The three-dimensional image of the defects is preferably displayed on a display unit, for example, a screen. By looking at the three-dimensional image of the defects on the display unit, the inspector is able to identify, possibly on-line, i.e., during the ongoing production or finishing process of the steel strip while the strip is moving, both surface defects and inhomogeneities in the interior of the steel strip on the display unit.

The at least one camera that is used to generate the image record is preferably a digital camera and, in particular, a line scan camera with a plurality of linearly disposed optical sensors, which extend at right angles relative to the direction of strip travel. Using this type of camera system, the entire surface of the steel strip can be acquired two-dimensionally and quickly while the strip is moving, since the camera system, which extends across the entire width of the steel strip, performs a line-by-line scan of the surface of the strip moving at strip speed.

The magnetic field-sensitive flux leakage sensor can also be a sensor array with a plurality of linearly disposed magnetic sensors which extend at right angles relative to the direction of strip travel. This allows the magnetic flux leakage on the surface of the steel strip to be detected line by line as well as two-dimensionally across the entire surface of the strip while the strip is moving.

The combined use of a line scan camera and a magnetic sensor array with a plurality of linearly disposed magnetic sensors offers a special advantage since both the line scan camera and the magnetic sensor array scan the surface of the steel strip line by line. This is attributable to the fact that the data (image record of the camera and flux leakage record of the magnetic sensor array) acquired by the line scan camera and the data acquired by the magnetic sensor array have the same structure and the same local mapping with respect to the (three-dimensional) coordinates of the steel strip. This makes it possible for the data (image record and flux leakage record) acquired by the camera and the data acquired by the magnetic sensor array to be simultaneously and uniformly analyzed in the image processing unit. This is due to the fact that the data of the line scan camera and of the magnetic sensor array (i.e., the image record and the flux leakage record) can be sent with the same data structure to the image processing unit for analysis, and an image processing program contained in or running on the image processing unit can process the records (image record and flux leakage record) with the same data structure and inspect them for anomalies. Thus, by superimposing the data of the image record and the data of the flux leakage record, it is possible to easily and quickly generate a location-dependent, three-dimensional image of the defects of the steel strip in the image processing unit.

By combining the data of the image record and the data of the flux leakage record in the image processing unit, it is possible to analyze the data of the flux leakage record in the same manner that the data of the image record are analyzed. As a result, the analysis of the flux leakage record is not limited solely to a statistical analysis in which only the inhomogeneities (for example, nonmetallic inclusions) in the interior of the steel strip per unit area (per m²) are included; instead, both the location and the extent and geometry of inhomogeneities in the interior of the steel strip are included and classified. To this end, the complex and extremely expensive image processing programs already used in conventional surface inspection systems can be employed. The present invention provides for combining a flux leakage sensor for detecting the magnetic flux leakage on the surface of the steel strip with an image processing unit of a surface inspection system, which image processing unit analyzes both the image record of the camera of the surface inspection system and (at the same time) the flux leakage record of the magnetic field-sensitive sensor.

### BRIEF DESCRIPTION OF THE DRAWINGS

These and additional advantages and features of the present invention follow from the embodiment example described in greater detail below with reference to the accompanying drawings. The drawings show:

FIG. 1: A diagrammatic representation of an embodiment of the system according to the present invention for inspecting a steel strip, by means of which the method according to an embodiment of the present invention can be carried out;

FIG. 2: An example of a two-dimensional image of the surface of a steel strip which has been inspected with the system shown in FIG. 1, with the two-dimensional image showing optically identifiable surface defects;

FIG. 3: An example of a diagrammatic representation of inhomogeneities in the interior of the steel strip which were identified during the inspection by means of the system shown in FIG. 1.

### DETAILED DESCRIPTION

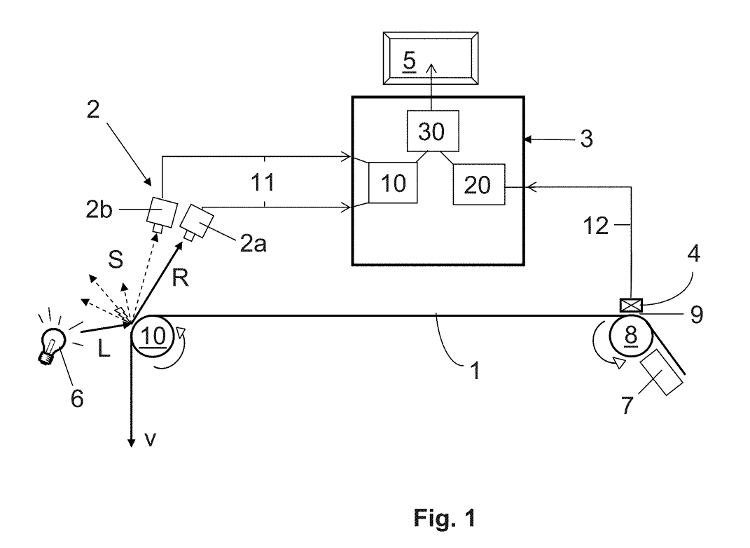

FIG. 1 shows a diagrammatic representation of a system according to the present invention for inspecting a steel strip 1. The system shown serves to perform the method according to the present invention and comprises a lighting unit 6 for illuminating the steel strip 1, a magnetizing unit 7 for magnetizing the steel strip 1, at least one camera 2 for optically scanning a surface of the steel strip 1, at least one magnetic field-sensitive sensor 4 for detecting the magnetic flux leakage on the surface of the steel strip 1, and an image processing unit 3 which is connected to the at least one camera 2 and to the flux leakage sensor 4.

The magnetizing unit 7 shown in FIG. 1 comprises a permanent magnet or an electromagnet as well as a magnetizing roll 8 disposed at a distance from the flux leakage sensor 4. The steel strip 1 is moved at a predefined strip speed which, depending on the production or finishing process preceding the inspection, can be in a range of 10 to 700 m/min, in a direction of strip travel v and, as shown in FIG. 1, is guided about the magnetizing roll 8. A gap 9 is formed between the outside circumference of the magnetizing roll 8 and the magnetically sensitive measuring surface of the flux leakage sensor 4. The steel strip 1 is passed through this gap 9 between the flux leakage sensor 4 and the magnetizing roll 8. The width of the gap 9 (i.e., the distance between the outside circumference of the magnetizing roll 8 and the magnetically sensitive surface of the flux leakage sensor 4) is adjustable so as to be able to position the flux leakage sensor 4 at a suitable measuring distance from the surface of the strip. Typical measuring distances are in the range of 0.1 mm to 1.0 mm.

The electromagnet or permanent magnet of the magnetizing unit 7 can be suitably integrated into the magnetizing roll 8. It is, however, also possible to dispose the electromagnet or permanent magnet downstream of the magnetizing roll 8, as indicated diagrammatically in FIG. 1.

Downstream of the magnetizing unit 7, the steel strip 1 is guided about a guide roll 10 disposed near the lighting unit 6 and the at least one camera 2. The lighting unit 6 illuminates at least one surface of the steel strip 1 with light L.

In the embodiment example shown in FIG. 1, the camera 2 comprises a bright field camera 2a and a dark field camera 2b. The bright field camera 2a captures the light R which is reflected from a surface of the steel strip 1, and the dark field camera 2b captures the scattered light S which is scattered from the surface of the strip. This allows the bright field camera 2a to detect optical anomalies on the surface of the strip, which appear as areas brighter or darker than the areas of the surface of the steel strip 1 that are free of defects. In the event of the presence of dirt particles or material elevations or depressions on the surface of the strip, from which the light L directed by the lighting unit 6 onto the surface of the steel strip 1 is scattered, the scattered light S can be captured by the dark field camera 2b. Thus, the dark field camera 2b detects, in particular, contaminations and depressions or material elevations on the surface of the strip.

The image data acquired by the bright field camera 2a and the dark field camera 2b are transmitted via data lines (wire-bound or wireless) 11 to the image processing unit 3. The image processing unit 3, which suitably comprises a PC or a laptop for data processing and data storage, contains image processing software, which processes the image data of the camera 2, and, based thereon, generates a two-dimensional image record 10 that defines a two-dimensional (optical) image of the surface of the steel strip 1. This two-dimensional image of the surface of the strip can be displayed on a display unit 5, which, for data transmission, is connected to the image processing unit 3.

The image processing software contained in the image processing unit 3 comprises a classification module, by means of which anomalies in the image data acquired by the camera 2 can be detected and classified. In order to be able to classify the detected anomalies in the image data of the image record 10, the image processing unit 3 comprises a storage unit with a classification database stored therein, in which a large number of typical surface defects as well as surface defects known from previous inspections are stored. To classify the anomalies detected in the image record 10 of the camera 2, these anomalies are compared with the (standardized) surface defects stored in the classification database. If the characteristics of the detected anomaly are consistent with the characteristics of a stored surface defect, the detected anomaly is correlated with a surface defect 11. Thus, a surface defect 11 detected and classified in this manner is marked or otherwise identified in a file containing the image record 10 of the cameras 2. In addition, the detected and classified surface defect 11 can also be displayed on the display unit 5, on which the two-dimensional image of the image record 10 is displayed. In the representation of a surface defect 11 on the display unit 5, both the location and the nature of the surface defect 11 can be marked.

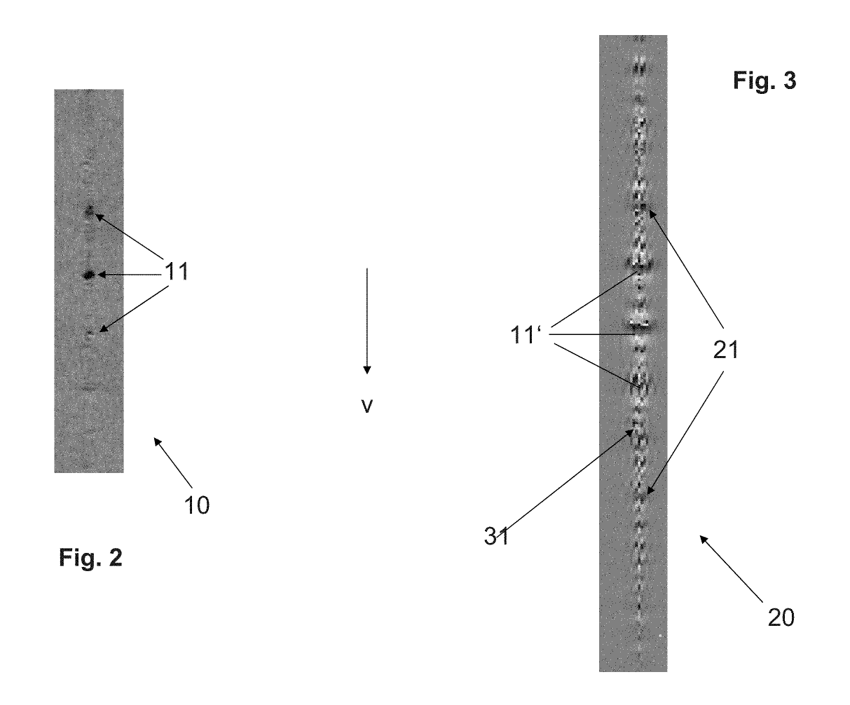

FIG. 2 shows an example of a two-dimensional image of a scanned surface of a steel strip 1, in which a plurality of detected and classified surface defects 11 are visible.

Magnetizing the steel strip 1 in the magnetizing unit 7 produces a magnetic flux leakage on the surface of the steel strip 1. The magnitude of the flux leakage depends on the magnetization and the permeability of the steel strip 1 as well as on the internal structure of the steel strip 1. If the magnetization and the permeability of the steel strip remain constant, the presence of a locally changing flux leakage that is detected on the surface of the steel strip 1 by means of the magnetic field-sensitive flux leakage sensor 4 is indicative of an internal defect, for example, a nonmetallic inclusion in the interior of the steel strip 1. If, for example, a nonmetallic inclusion is present in the interior of the steel strip 1, the magnetic field lines in the interior of the steel strip 1 are directed around the nonmetallic inclusion, which produces an anomaly in the location-dependent flux leakage image on the surface of the steel strip 1. Such anomalies can be detected by the magnetic field-sensitive flux leakage sensor 4. The flux leakage data (location-dependent flux leakage values) generated by the flux leakage sensor 4 are transmitted by a data line 12 to the image processing unit 3, wherein the data are processed to generate a flux leakage record 20. The flux leakage record 20 contains spatially-resolved flux leakage data and thereby defines a location-dependent image of the flux leakage detected by the flux leakage sensor 4. The presence of anomalies in the flux leakage record 20 is indicative of inhomogeneities, particularly nonmetallic influences, in the interior of the steel strip 1. The flux leakage record 20 therefore contains information concerning the location as well as the structure and morphology of inhomogeneities in the interior of the steel strip.

The flux leakage record 20 generated in the image processing unit 3 is checked for anomalies by the image processing software contained in the image processing unit 3. When an anomaly is detected in the flux leakage record 20, the characteristics of the detected anomaly are compared with the characteristics of anomalies known from previous flux leakage measurements in the flux leakage record that are stored in a flux leakage database. If the characteristics of an anomaly in the currently generated flux leakage record 20 are consistent with the characteristics of an anomaly stored in the flux leakage database, the anomaly detected in the current flux leakage record 20 can be correlated with an anomaly known from and classified in previous inspections in a flux leakage record. In this manner, the detected anomalies can be classified in the current flux leakage record 20 of the steel strip 1 and correlated with a typical inhomogeneity 21 in the interior of the steel strip. This makes it possible to identify not only the presence of a defect in the flux leakage record 20 but also its location as well as the nature, extent and geometry and the morphology of the inhomogeneity 21.

An example of a diagrammatic representation of a flux leakage record 20 and inhomogeneities 21 present therein can be seen in FIG. 3.

The image processing software of the image processing unit 3 combines the data of the image record 10 and the data of the flux leakage record 20 and, due to this data combination, is able to generate a three-dimensional image 30 of the defects. This three-dimensional image 30 of the defects can be displayed on the display unit 5. The fact that the data of the image record 10 and the data of the flux leakage record 20 are combined has the effect that the three-dimensional image 30 of the defects contains both information concerning optically visible surface defects 11 and inhomogeneities 21 in the interior of the steel strip 1. Thus, the three-dimensional image 30 of the defects contains not only information concerning defects that are optically visible on the surface, but also information concerning the internal structure of the steel strip in the depth direction.

As a result, it is also possible to detect and to classify contiguous anomalies and defects in the three-dimensional image 30 of the defects, even if a defect appears only in some areas as a surface defect on the surface of the steel strip 1 (and is identifiable as such in the image record 10) and, at the same time, is present at least in some areas as an inhomogeneity (for example, as a nonmetallic inclusion) on the in the interior of the steel strip, without being visible on the surface (as a surface defect).

An example of such a situation can be seen in FIGS. 2 and 3, which show portions of a two-dimensional image of the surface of a selected area of the steel strip 1 (in FIG. 2) and a flux leakage record 20 of the same area of the steel strip 1. In FIG. 2, only the (optical) surface defects 11 are visible, and in FIG. 3, mainly the inhomogeneities 21 identified in the flux leakage record 20 can be seen, which inhomogeneities are indicative of internal nonmetallic inclusions in the steel strip 1. The surface defects 11, which can be seen in the image record 10 of FIG. 2, can also be seen at least to some extent in the flux leakage record 20 of FIG. 3. By combining the data of the image record 10 of FIG. 2 and the data of the flux leakage record 20 of FIG. 3, one can see that the anomalies in the image record 10 and in the flux leakage record 20 have been caused by a locally contiguous defect in the internal and superficial structure of the steel strip 1. The defect 31 involved is substantially an internal defect that extends longitudinally in the direction of strip travel v of the steel strip 1 (internal inhomogeneity in the steel strip 1), and that can also be seen, although only in some areas (i.e., in the areas marked by reference character 11′ in FIG. 3), on the surface of the steel strip 1, but it is otherwise present only below the surface in the interior of the steel strip 1.

Due to the fact that the method according to the present invention combines the data of the image record 10 and the data of the flux leakage record 20, it is possible, in the three-dimensional image 30 of the defects, to detect, visualize and classify those defects which are visible only in some areas as surface defects 11 on the surface of the steel strip and which in the remaining area propagate in the form of an inhomogeneity 21 in the interior of the steel strip.

The three-dimensional image 30 of the defects generated according to the present invention by combining the data of the image record 10 and the data of the flux leakage record 20 can preferably be displayed in-line on the display unit 5, i.e., while the steel strip 1 exiting an ongoing production or finishing process is moving at the predefined strip speed in the direction of strip travel v.

As a result, it is possible, for example, to detect, classify and visualize both surface defects 11 (from the image record 10) and inhomogeneities 21 in the interior of the steel strip (from the flux leakage record 20) during an ongoing production or finishing process of the steel strip 1 and, if necessary, to intervene in the production or finishing process in order to prevent the development of additional surface defects and/or inhomogeneities in the interior of the steel strip. At the same time, the method according to the present invention also allows the detection of contiguous defects in the three-dimensional image 30 of the defects, which can be identified in some areas as surface defects 11 and in some areas as an inhomogeneity 21 in the interior of the steel strip, as well as their classification.

To be able to scan the surface of the strip two-dimensionally while the steel strip 1 is moving, the at least one camera 2 is preferably a digital line scan camera having a plurality of linearly disposed optical sensors, with the camera 2 being disposed relative to the moving steel strip 1 in such a way that the optical sensors disposed at a distance from each other extend at right angles relative to the direction of strip travel and across the entire width of the steel strip. Using this design and configuration of the camera 2, the surface of the steel strip 1 moving at the strip speed can be scanned line by line. If a bright field camera 2a and a dark field camera 2b are used as proposed by the embodiment example shown in FIG. 1, both cameras are preferably line scan cameras.

In addition, the flux leakage sensor 4 is preferably configured in the form of a sensor array with a plurality of linearly disposed magnetic sensors, with the magnetic sensors disposed at a distance from each other also extending at right angles relative to the direction of strip travel and across the entire width of the steel strip. Using this design and configuration of the flux leakage sensor 4 in the form of a sensor array, the magnetic flux leakage can also be detected line by line across the entire surface of the strip while the steel strip is moving. The flux leakage sensor 4 can also comprise a plurality of sensor lines which are disposed one behind another in the direction of strip travel v. Depending on the number of magnetic sensors in the sensor matrix (which may comprise far more than a thousand magnetic sensors), a flux leakage sensor 4 that is designed as a multiple line senor matrix makes it possible to detect internal inclusions with a spherical diameter in the range from 50 μm to 100 μm in steel strips with thicknesses in a range from 100 μm to 500 μm.

The magnetic sensors of the flux leakage sensor 4 involved can be, for example, induction coils, giant magnetoresistive sensors (GMR sensors), anisotropic magnetoresistive sensors (AMR sensors), tunneling magnetoresistive sensors (TMR sensors) or Hall sensors.

The design of the camera 2 as a digital line scan camera and of the flux leakage sensor 4 as a sensor array also offers advantages with respect to the data structure of the generated image record 10 and the flux leakage record 20 since the location dependency of the two-dimensional optical image resulting from the image record 10 and of the magnetic flux leakage resulting from the flux leakage record 20 has the same (line) structure with respect to the location dependency. As a result, it is possible to process both the image record 10 and the flux leakage record 20 using a single image processing software and, by superimposing the data of the image record 10 and the data of the flux leakage record 20 upon each other, to generate a three-dimensional record (three-dimensional image 30 of the defects), which record contains both information about the structure of the steel strip on the surface and information about the depth with respect to internal inclusions or other inhomogeneities.

What is claimed is:

1. A method of inspecting a steel strip, wherein at least one surface of the steel strip is illuminated and scanned by at least one camera in order to generate an image record that defines a two-dimensional image of the scanned surface, and wherein the image record is sent to an image processing unit, with the image processing unit subjecting the image record to the detection of defects, and, if a surface defect is detected, classifying the detected surface defect, wherein the steel strip is magnetized and that the magnetic flux leakage on the surface of the steel strip is detected by at least one magnetic field-sensitive sensor in order to detect inhomogeneities in the interior of the steel strip, with the flux leakage sensor generating a flux leakage record that is sent to the image processing unit and that is subjected by the image processing unit to the detection of defects so as to detect inhomogeneities in the interior of the steel strip.

2. The method of claim 1, wherein upon detection of an inhomogeneity in the image processing unit, the detected inhomogeneity is classified.

3. The method of claim 1, wherein the image record and the flux leakage record are combined in the image processing unit, specifically by superimposition, so as to generate a three-dimensional image of the defects of the steel strip.

4. The method of claim 3, wherein the defects captured in the three-dimensional image of the defects are classified into predefined classes of defects.

5. The method of claim 3, wherein the three-dimensional image of the defects is displayed on a display unit.

6. The method of claim 1, wherein the steel strip is moving at a strip speed in a direction of strip travel.

7. The method of claim 6, wherein the camera is a digital line scan camera with a plurality of linearly disposed optical sensors that extend at right angles relative to the direction of strip travel.

8. The method of claim 6, wherein the magnetic sensitive sensor used to detect the magnetic leakage field is a sensor array with a plurality of linearly disposed magnetic sensors that extend at right angles relative to the direction of strip travel.

9. The method of claim 1, wherein the surface of the steel strip is illuminated by a lighting unit that emits light and is scanned by a first camera and a second camera, with the first camera capturing the light that is reflected from the surface of the steel strip and with the second camera capturing the light that is scattered from the surface of the steel strip.

10. The method of claim 1, wherein in order to magnetize the steel strip, the strip is guided about a magnetizing roll and passed through a magnetizing unit comprising an electromagnet or a permanent magnet.

11. The method of claim 10, wherein the flux leakage sensor is disposed opposite to the magnetizing roll and the steel strip is passed through a gap between the magnetizing roll and the flux leakage sensor.

12. A system for inspecting a steel strip, preferably for carrying out the method of claim 1, comprising
a lighting unit used to illuminate the steel strip,
a magnetizing unit used to magnetize the steel strip,
at least one camera used to optically scan a surface of the steel strip and to generate an image record that defines a two-dimensional image of the scanned surface,
an image processing unit that is connected to the camera and to which the image record is sent for data processing and that is able to detect optical surface defects in the image record to and classify the detected surface defects,
and at least one magnetic field-sensitive flux leakage sensor used to detect the magnetic leakage flux on the surface of the steel strip and to generate a flux leakage record, with the flux leakage sensor being connected to the image processing unit for transmitting the flux leakage record to the image processing unit, and with the image processing unit being configured so as to be able to detect inhomogeneities in the interior of the steel strip from the flux leakage record.

13. The system of claim 12, wherein the flux leakage sensor comprises induction coils, giant magnetoresistive sensors (GMR sensors), anisotropic magnetoresistive sensors (AMR sensors), tunneling magnetoresistive sensors (TMR sensors) or Hall sensors so as to be able to detect the magnetic flux leakage density.

14. The system of claim 12, wherein the magnetizing unit comprises an electromagnet or a permanent magnet and a magnetizing roll disposed at a distance from the flux leakage sensor, with the steel strip being guided about the magnetizing roll and passed through the magnetic field generated by the electromagnet or the permanent magnet and through a gap that is formed between the magnetizing roll and the flux leakage sensor.

15. The method of claim 12, wherein the camera is a digital line scan camera with a plurality of linearly disposed optical sensors and wherein the magnetic field-sensitive flux leakage sensor is a sensor array with a plurality of linearly disposed magnetic sensors.
